(19) United States
(12) Patent Application Publication
(10) Pub. No.: US 2013/0335578 A1
(43) Pub. Date: Dec. 19, 2013

(54) Ambient Adaptive Objective Image Metric

(71) Applicants: Sachin G. Deshpande, Camas, WA (US); Louis Joseph Kerofsky, Camas, WA (US)

(72) Inventors: Sachin G. Deshpande, Camas, WA (US); Louis Joseph Kerofsky, Camas, WA (US)

(21) Appl. No.: 13/526,805

(22) Filed: Jun. 19, 2012

(51) Int. Cl. H04N 17/00

(52) U.S. Cl. 348/180; 348/E17.001

(57) ABSTRACT

A system and method are provided for measuring image quality using an ambient adaptive objective brightness metric. The method accepts an electronically formatted original image (I), and also accepts an electronically formatted brightened image (B), obtained by modifying the original image. For example, the brightened image (B) may be an illumination-modified original image. The method also accepts a relative ambient illumination value (λ). A dynamic reference AI=Iλ is generated, and the brightened image (B) is compared to the dynamic reference (AI).

### BACKGROUND OF THE INVENTION

1. Field of the Invention

This invention generally relates to video processing and, more particularly, to a system and method for establishing an ambient adaptive objective image metric.

2. Description of the Related Art

As noted in Wikipedia, video quality is a characteristic of video passed through a video transmission/processing system—a formal or informal measure of perceived video degradation, which is typically compared to the original video image. Video processing systems may introduce some amounts of distortion or artifacts in the video signal, so video quality evaluation is an important problem.

In many video processing systems, the ability to quantify the quality of an image which agrees with human perception plays an important role. The most reliable method is to ask human subjects to rate the quality of a given image. However, this method is time consuming and expensive, and thus is impractical in many applications. Further, this method cannot be used in real-time processing.

Objective video evaluation techniques are mathematical models that approximate results of subjective quality assessment, but are based on criteria and metrics that can be measured objectively and automatically evaluated by a computer program. Objective methods are classified based on the availability of the original video signal, which is considered to be of high quality (generally not compressed). Therefore, they can be classified as Full Reference Methods (FR), Reduced Reference Methods (RR) and No-Reference Methods (NR). FR metrics compute the quality difference by comparing every pixel in each image of the distorted video to its corresponding pixel in the original video. RR metrics extract some features of both videos and compare them to give a quality score. They are used when all the original video is not available, e.g. in a transmission with a limited bandwidth. NR metrics try to assess the quality of a distorted video without any reference to the original video. These metrics are usually used when the video coding method is known.

Other conventional ways of evaluating quality of digital video processing system (e.g. video codec like DivX, Xvid) are a calculation of the signal-to-noise ratio (SNR) and peak signal-to-noise ratio (PSNR) between the original video signal and signal passed through this system. PSNR is the most widely used objective video quality metric. However, PSNR values do not perfectly correlate with a perceived visual quality due to the non-linear behavior of the human visual system. Recently, a number of more complicated and precise metrics were developed, for example UQI, Vector Quantized Animation (VQM), Perceptual Evaluation of Video Quality (PEVQ), Structural Similarity (SSIM), VQuad-HD and Czenakowski Distance (CZD). Based on a benchmark by the Video Quality Experts Group (VQEG) in the course of the Multimedia Test Phase 2007-2008 some metrics were standardized as ITU-T Rec. J.246 (RR), J.247 (FR) in 2008 and J.341 (FR HD) in 2011.

Some of the most widely used image quality metrics include Structural Similarity (SSIM), see Z. Wang, A. Bovik, H. Sheikh, and E. Simoncelli, “Image quality assessment: From error visibility to structural similarity,” IEEE Trans. Image Process., vol. 13, pp. 600-612, 2004, and multi-scale SSIM (MS-SSIM), see Z. Wang, E. P. Simoncelli, and A. C. Bovik, “Multi-scale structural similarity for image quality assessment,” in Proc. Asilomar Conf. on Signals, Systems, and Computers, November 2003. Some of the most recent advanced and dedicated VQA metrics include: the MOVIE metric, proposed by K. Seshadrinathan and A. C. Bovik, “Motion tuned spatio-temporal quality assessment of natural videos,” IEEE Transactions on Image Processing, vol. 19, no. 2, pp. 335-350, 2010, and the video quality model (VQM) metric described by M. H. Pinson and S. Wolf, “A new standardized method for objectively measuring video quality,” IEEE Transactions on Broadcasting, vol. 50, no. 3, pp. 312-322, 2004.

The performance of an objective video quality metric is evaluated by computing the correlation between the objective scores and the subjective test results. The latter is called mean opinion score (MOS). The most frequently used correlation coefficients are: linear correlation coefficient, Spearman's rank correlation coefficient, kurtosis, kappa coefficient, and outliers ratio.

Full Reference Vector Quantized Animation (VQA) assumes the availability of the original (reference) image, which is considered as perfect quality, while measuring the quality of the processed (and most of the time is distorted) image. Unfortunately, the Full Reference metric prior art uses a fixed reference images, instead of one that is dynamically adjusted for the ambient environment.

The SSIM index is a method for measuring the similarity between two images. The SSIM index is a full reference metric, in other words, the measuring of image quality based on an initial uncompressed or distortion-free image as reference. SSIM is designed to improve on traditional methods like PSNR and mean squared error (MSE), which have proved to be inconsistent with human eye perception. The difference with respect to other techniques mentioned previously such as MSE or PSNR, is that these approaches calculate numerical errors, while on the other hand, SSIM considers image degradation as perceived change in structural information reflecting how a human perceives the error. Structural information is the idea that the pixels have strong inter-dependencies especially when they are spatially close. These dependencies carry important information about the structure of the objects in the visual scene. The SSIM metric is calculated on various windows of an image. The measure between two windows x and y of common size N×N is:

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )}$$

where μₓ is the average of x;

μ_{y} is the average of y;

σₓ² is the variance of x;

σ_{y}² is the variance of y;

σ_{xy} is the covariance of x and y;

σ₁=(k₁L)² and σ₂=(k₂L)² are two variables to stabilize the division with weak denominator;

L is the dynamic range of the pixel-values (typically this is

2^{#bits per pixel}−1); and,

k₁=0.01 and k₂=0.03 by default.

In order to evaluate the image quality this formula is applied only on luma. The resultant SSIM index is a decimal value between −1 and 1, and value 1 is only reachable in the case of two identical sets of data. Typically it is calculated on window sizes of 8×8. However, SSIM is unable to account of the dynamic range of the reference, which can result in a distorted (algorithm brightened) image.

Some conventional objective metrics implicitly assume a fixed viewing condition i.e. an ambient light level. In practice, it is known that perceived image quality can be improved under harsh viewing conditions by modifying the image. In this case, the original image should no longer serve as the highest quality since it is known that the original image is not the most preferred.

It would be advantageous if an objective metric could be used to determine the quality of an image evaluated under a range of viewing conditions, in a manner that highly correlates with human (subjective) ratings.

### SUMMARY OF THE INVENTION

Disclosed herein is an ambient adaptive objective metric for objectively evaluating the quality of brightened image using brightness enhancement algorithms. A dynamic reference image is created and used that is ambient dependent. Thus, the approach takes the original input image and creates a reference image based on ambient conditions and then utilizes this image as the reference image in the objective metric calculation. The conventional Full Reference metric prior art uses a fixed reference images instead of a dynamically selected reference image. More explicitly, the method disclosed herein extends the baseline Structural Similarity (SSIM) metric to account for different dynamic ranges of the reference and distorted (algorithm brightened) images. As a result, the ambient adaptive objective metric is better correlated with perceived subjective quality under a variety of viewing conditions.

Accordingly, a method is provided for measuring image quality using an ambient adaptive objective brightness metric. The method accepts an electronically formatted original image (I), and also accepts an electronically formatted brightened image (B), obtained by modifying the original image. For example, the brightened image (B) may be an illumination-modified original image. The method also accepts a relative ambient illumination value (λ). A dynamic reference AI=Iλ is generated, and the brightened image (B) is compared to the dynamic reference (AI).

In one aspect, the method accepts a relative ambient illumination value (λ) for a first illumination environment, and in response to comparing the brightened image (B) to the dynamic reference (AI), presents the brightened image (B) in the first illumination environment. In another aspect, comparing the brightened image (B) to the dynamic reference (AI) includes comparing luminance, contrast, and structure components.

Additional details of the above-described method and a device for measuring image quality using an ambient adaptive objective brightness metric are provided below.

### BRIEF DESCRIPTION OF THE DRAWINGS

FIG. 1 is a schematic block diagram of a device for measuring image quality using an ambient adaptive objective brightness metric.

FIG. 2 is a high level flowchart of an objective metric calculation.

FIG. 3 depicts a set of gray scale ramp photographic type images.

FIG. 4 is a graph depicting the results of using the Mean Square Error (MSE) objective metric to measure the B₁ and B2 brightening algorithms.

FIG. 5 is a graph depicting the results of using the ambient adaptive objective metric (SSIM_{AA}) to measure the B₁ and B₂ brightening algorithms.

FIG. 6 is a flowchart illustrating a method for measuring image quality using an ambient adaptive objective brightness metric.

### DETAILED DESCRIPTION

As used in this application, the terms “component,” “module,” “system,” “device”, and the like may be intended to refer to an automated computing system entity, such as hardware, firmware, a combination of hardware and software, software, software stored on a computer-readable medium, or software in execution. For example, a component may be, but is not limited to being a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

The computer devices described below typically employ a computer system with a bus or other communication mechanism for communicating information, and a processor coupled to the bus for processing information. The computer system may also include a main memory, such as a random access memory (RAM) or other dynamic storage device, coupled to the bus for storing information and instructions to he executed by processor. These memories may also be referred to as a computer-readable medium. The execution of the sequences of instructions contained in a computer-readable medium may cause a processor to perform some of the steps associated with calculating an ambient adaptive objective brightness metric, and comparing brightened images to the adaptive reference. Alternatively, some of these functions may be performed in hardware. The practical implementation of such a computer system would be well known to one with skill in the art.

As used herein, the term “computer-readable medium” refers to any medium that participates in providing instructions to a processor for execution. Such a medium may take many forms, including but not limited to non-volatile media, volatile media, and transmission media. Non-volatile media includes, for example, optical or magnetic disks. Volatile media includes dynamic memory. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge such as an SD card or USB dongle, or any other medium from which a computer can read.

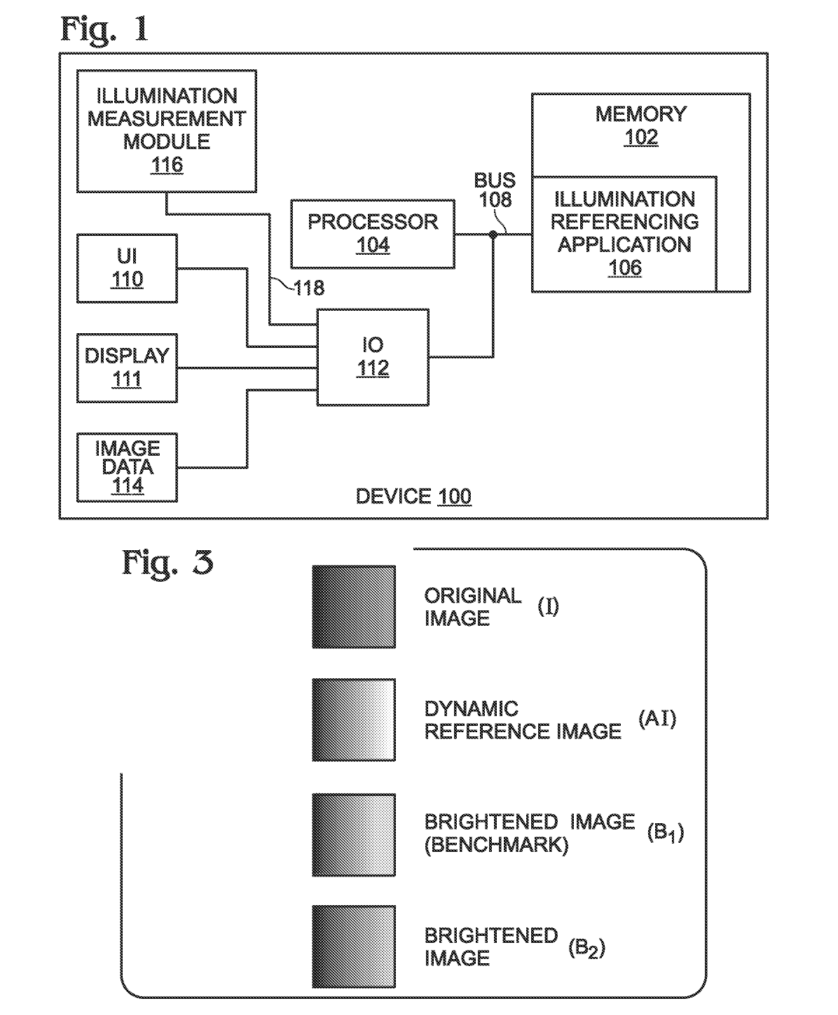

FIG. 1 is a schematic block diagram of a device for measuring image quality using an ambient adaptive objective brightness metric. The device 100 comprises a non-transitory memory 102 and a processor 104. An illumination referencing application 106 is enabled as a sequence of instructions stored in the memory 102 and executed by the processor 104. The device 100 may be enabled as: a personal computer (PC), Mac computer, tablet, workstation, server, PDA, handheld device, camera, electronic reader, cell phone, or single-function device. The processor or central processing unit (CPU) 104 may be connected to memory 102 via an interconnect bus 108. The memory 102 may include a main memory, a read only memory, and mass storage devices such as various disk drives, tape drives, etc. The main memory typically includes dynamic random access memory (DRAM) and high-speed cache memory. In operation, the main memory stores at least portions of instructions and data for execution by the processor 104. The device 100 may further comprise an appropriate user interface (UI) 110, such as a keyboard, mouse, or touchscreen, and a display 111, which are connected via an input/output (IO) port 112. The device 100 may have an interface 114 to accept image data.

The illumination referencing application 106 accepts an electronically formatted original image (I), and an electronically formatted brightened image (B), obtained by modifying the original image. The illumination referencing application 106 also accepts a relative ambient illumination value (λ). The original image (I) may be supplied via interface 114 or accessed from memory 102. The brightened image (B) may be a result of the processor 104 processing the original image (I), or it may be supplied via interface 114. The relative ambient illumination value (λ) may be accessed from memory 102, received via interface 114, or measured, as described in more detail below. In one aspect, the illumination referencing application 106 accepts a brightened image (B) expressed with a resolution of X bits, and generates a dynamic reference AI expressed with a resolution of greater than X bits.

The illumination referencing application 106 generates a dynamic reference AI=Iλ, and supplies the result of comparing the brightened image (B) to the dynamic reference (AI). For example, the result may he supplied via the UI 110 or supplied to the processor for image comparison processing.

In one aspect, the illumination referencing application 106 accepts a brightened image (B) that is an illumination-modified original image. For example, an electronic reader may accept a brightened image (B) based upon the assumption that the original image (I) is not bright enough for a particular application (e.g., the reader is being used in an outdoor environment). In this example, the illumination referencing application 106 accepts a relative ambient illumination value (λ) for a first (e.g., outdoor) illumination environment. The display monitor 111 is configured to present the brightened image (B) in the first illumination environment in response to the illumination referencing application comparison of the brightened image (B) to the dynamic reference (AI), assuming a positive result of the comparison.

In another aspect, the device 100 may further comprise an illumination measurement module 116 configured to measure illumination in the first illumination environment. The illumination measurement module 116 has an output on line 118 to supply the relative ambient illumination value (λ) for the first illumination environment to the illumination referencing application. For example, if the illumination measurement module 116 measures X=a radiant flux value, and the display monitor 111 has a first display gamma characteristic (γ), then the illumination referencing application 106 calculates λ=(X/Y)^{1/γ}, where Y is a reference ambient illumination corresponding to the first illumination environment. The reference ambient illumination is a value chosen to normalize the ambient light level. This value can be selected based upon a “typical” or indoor level, where the original unmodified image is assumed to be the reference. Radiant flux, or radiant power is a measure of the total power of electromagnetic radiation, including the radiation in non-visible spectrums.

Gamma correction, gamma nonlinearity, gamma encoding, or simply gamma, is the name of a nonlinear operation used to code and decode luminance or tristimulus values in video or still image systems. Gamma encoding of images is required to compensate for properties of human vision, to maximize the use of the bits or bandwidth relative to how humans perceive light and color. Human vision under common illumination conditions (not pitch black or blindingly bright) follows an approximate gamma or power function. If images are not gamma encoded, they allocate too many bits or too much bandwidth to highlights that humans cannot differentiate, and too few bits/bandwidth to shadow values that humans are sensitive to and would require more bits/bandwidth to maintain the same visual quality.

A common misconception is that gamma encoding was developed to compensate for the input-output characteristic of cathode ray tube (CRT) displays. In CRT displays the electron-gun current, and thus light intensity, varies nonlinearly with the applied anode voltage. Altering the input signal by gamma compression can cancel this nonlinearity, such that the output picture has the intended luminance. However, the gamma characteristics of the display device do not play a factor in the gamma encoding of images and video—they need gamma encoding to maximize the visual quality of the signal,regardless of the gamma characteristics of the display device.

More explicitly, the illumination referencing application 106 compares the brightened image (B) to the dynamic reference (AI) by comparing luminance, contrast, and structure components. The illumination referencing application 106 compares brightened image (B) and dynamic reference (AI) contrast components by calculating:

$$C ( AI , B ) = \frac{2 {σ}_{AI} {σ}_{B} + {C}_{2}}{{σ}_{AI}^{2} + {σ}_{B}^{2} + {C}_{2}}$$

where σ=a standard deviation value; and,

C₂=a first constant.

The illumination referencing application 106 compares brightened image (B) and dynamic reference (AI) structure components by calculating:

$$S ( AI , B ) = \frac{{σ}_{AIB} + {C}_{3}}{{σ}_{AI} {σ}_{B} + {C}_{3}}$$

where C₃=a second constant.

The illumination referencing application 106 compares brightened image (B) and dynamic reference (AI) luminance components by calculating:

$$L ( AI , B ) = \frac{2 {μ}_{AI} {μ}_{B} + {K}_{1}}{{μ}_{AI}^{2} + {μ}_{B}^{2} + {K}_{1}}$$

where μ=a mean value;
K₁=K²L_{AI}L_{B};
K=a third constant, <<1;
L_{AI}=dynamic range in pixel values of AI; and,
L_{B}=dynamic range of pixel values of B.

Subsequent to calculating the luminance, contrast, and structure components, the illumination referencing application 106 calculates an ambient adaptive (AA) objective matrix as follows:

SSIM_{AA}(AI,B)=L(AI,B)^{α}C(AI,B)^{β}S(AI,B)^{η}

where α,β,η are weighting constants.

It should be noted that for the contrast and structure calculations, a MS-SSIM approach is used. However, the luminance calculation has been modified to incorporate the dynamic reference (AI).

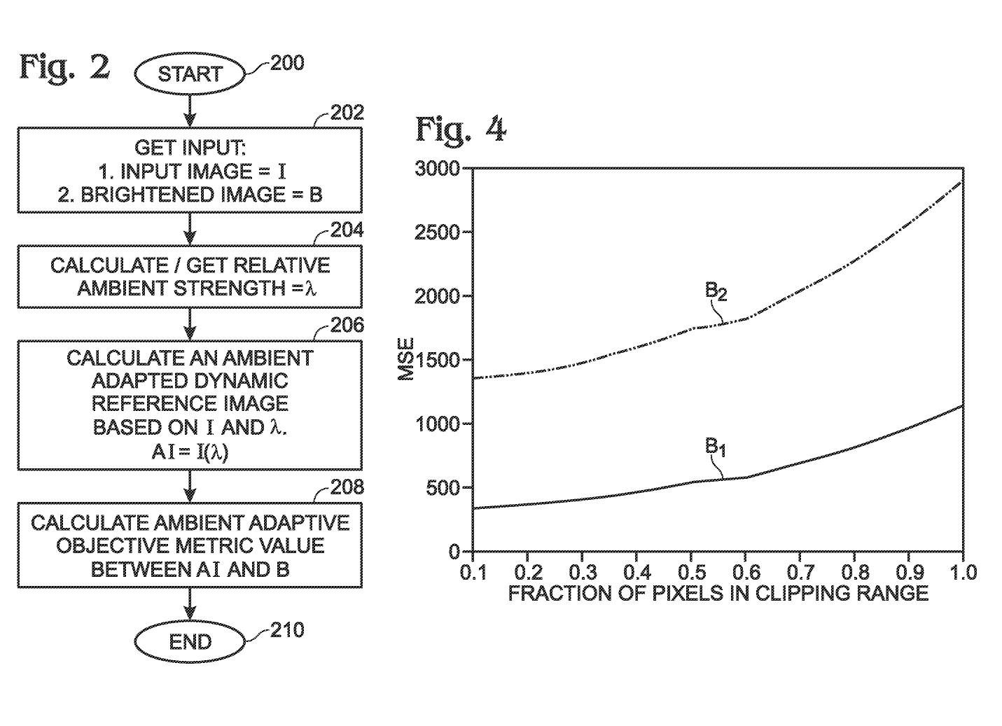

FIG. 2 is a high level flowchart of an objective metric calculation. The flowchart begins at Step 200. In Step 202, the original (input) image (I) and brightened image (B) are obtained. In Step 204 the ambient illumination value or ambient strength (λ) is obtained or calculated (measured). In Step 206, the dynamic reference AI=Iλ is calculated. In Step 208 AI and B are contrasted by calculating the ambient adaptive objective metric values.

FIG. 3 depicts a set of gray scale ramp photographic type images. From top to bottom are shown an original image (I), dynamic reference image (AI), an image (B₁) brightened by a benchmark algorithm (which does a hard clipping), and an image (B₂) brightened using an algorithm that does not perform hard clipping. Hard clipping limits all values to a maximum threshold, producing a flat cutoff, while ‘soft clipping’ is gentler in that soft clipped values continue to follow the original value at a reduced gain. As can be observed, the non-hard clipping algorithm (B₂) is able to perform brightening at the same time preserving the original image structure. In contrast, the benchmark algorithm (B₁) results in brightening the image but also results in banding in the clipping region. The clipping region is defined as the range of all gray level values above a threshold value of gray level.

FIG. 4 is a graph depicting the results of using the Mean Square Error (MSE) objective metric to measure the B₁ and B₂ brightening algorithms. From the figure it can be observed that the MSE metric provides a lower value for the benchmark (B₁) algorithm as compared to the B₂ algorithm. However, when subjectively (visually) evaluated, the B₂ was judged to be better than benchmark brightened image B₁.

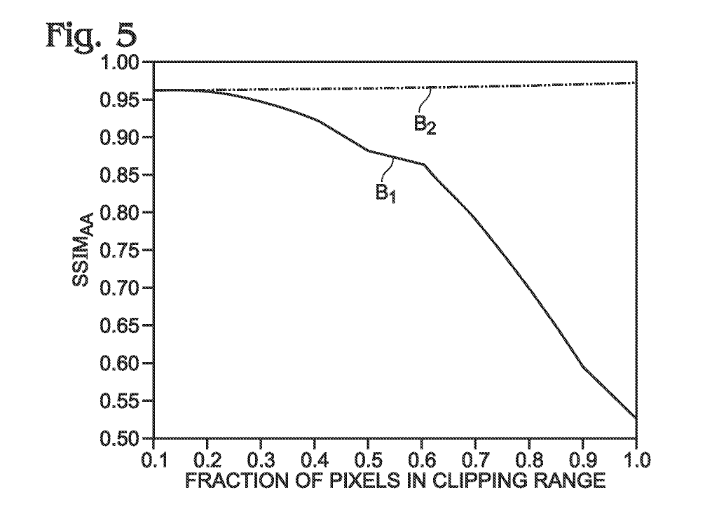

FIG. 5 is a graph depicting the results of using the ambient adaptive objective metric (SSIM_{AA}) to measure the B₁ and B₂ brightening algorithms. As can be observed from figure, the SSIM_{AA} shows results which match the subjective quality results. Furthermore, it can be seen that SSIM_{AA} algorithm maintains a high metric value even as the percentage of pixels in the clipping region increases. In comparison, the benchmark algorithm's perceived quality reduces as the percentage of pixels in the clipping region increases.

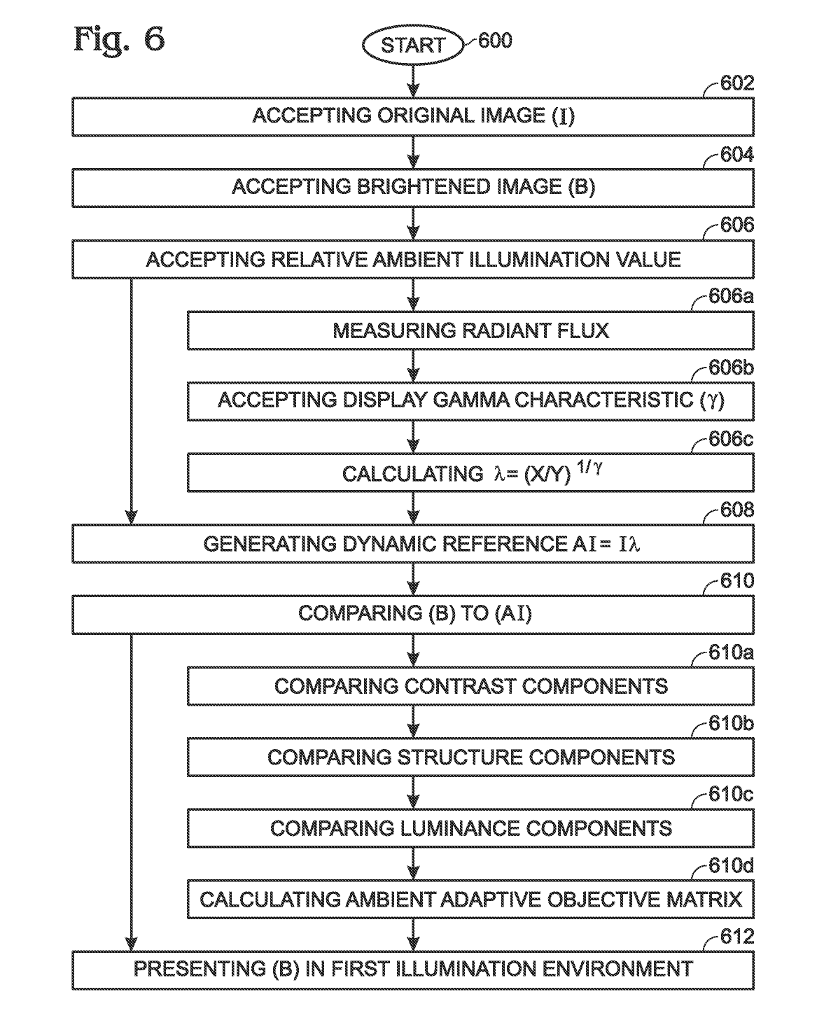

FIG. 6 is a flowchart illustrating a method for measuring image quality using an ambient adaptive objective brightness metric. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 600.

Step 602 accepts an electronically formatted original image (I). Step 604 accepts an electronically formatted brightened image (B), obtained by modifying the original image. For example, the brightened image (B) may be an illumination-modified original image. Step 606 accepts a relative ambient illumination value (λ). Step 608 generates a dynamic reference AI=Iλ. Step 610 compares the brightened image (B) to the dynamic reference (AI). In one aspect, accepting the brightened image (B) in Step 614 includes accepting a brightened image (B) expressed with a resolution of X bits, and generating the dynamic reference (AI) in Step 608 includes generating a dynamic reference (AI) expressed with a resolution of greater than X bits.

In another aspect, accepting the relative ambient illumination measurement (λ) in Step 606 includes an accepting a relative ambient illumination value (λ) for a first illumination environment. Then, in response to comparing the brightened image (B) to the dynamic reference (AI), Step 612 presents the brightened image (B) in the first illumination environment. For example, accepting the relative ambient illumination value (λ) for the first illumination environment may include measuring ambient illumination in the first illumination environment. Measuring the ambient illumination value in the first illumination environment may be enabled in the following substeps. Step 606a measures X=a radiant flux value. Step 606b accepts a first display gamma characteristic (γ). Step 606c calculates:

λ=(X/Y)^{1/γ}, where Y is a reference ambient illumination corresponding to a reference illumination environment. Then, presenting the brightened image (B) in Step 612 includes presenting the brightened image (B) on the first display.

In another aspect, comparing the brightened image (B) to the dynamic reference (AI) in Step 610 includes comparing luminance, contrast, and structure components. Step 610a compares the brightened image (B) and dynamic reference (AI) contrast components as follows:

$$C ( AI , B ) = \frac{2 {σ}_{AI} {σ}_{B} + {C}_{2}}{{σ}_{AI}^{2} + {σ}_{B}^{2} + {C}_{2}}$$

where σ=a standard deviation value; and,

C₂=a first constant.

Step 610b compares the brightened image (B) and dynamic reference (AI) structure components includes calculating as follows:

$$S ( AI , B ) = \frac{{σ}_{AIB} + {C}_{3}}{{σ}_{AI} {σ}_{B} + {C}_{3}}$$

where C₃=a second constant.

Step 610c compares the brightened image (B) and dynamic reference (AI) luminance components includes calculating as follows:

$$L ( AI , B ) = \frac{2 {μ}_{AI} {μ}_{B} + {K}_{1}}{{μ}_{AI}^{2} + {μ}_{B}^{2} + {K}_{1}}$$

where μ=is a mean value;
K₁=K²L_{AI}L_{B};
K=a third constant, <<1;
L_{AI}=dynamic range in pixel values of AI; and,
L_{B}=dynamic range of pixel values of B.

Subsequent to calculating the luminance, contrast, and structure components, Step 610d calculates an ambient adaptive (AA) objective matrix as follows:

SSIM_{AA}(AI,B)=L(AI,B)^{α}C(AI,B)^{β}S(AI,B)^{η}

where α,β,η are weighting constants.

A system and method have been provided for measuring image quality using an ambient adaptive objective brightness metric. Examples of particular process steps have been presented to illustrate the invention. However, the invention is not limited to merely these examples. Other variations and embodiments of the invention will occur to those skilled in the art.

We claim:

1. A method for measuring image quality using an ambient adaptive objective brightness metric, the method comprising:
accepting an electronically formatted original image (I);
accepting an electronically formatted brightened image (B), obtained by modifying the original image;
accepting a relative ambient illumination value (λ);
generating a dynamic reference AI=Iλ; and,
comparing the brightened image (B) to the dynamic reference (AI).

2. The method of claim 1 wherein accepting the brightened image (B) includes accepting an illumination-modified original image.

3. The method of claim 1 wherein accepting the relative ambient illumination measurement (λ) includes an accepting a relative ambient illumination value (λ) for a first illumination environment; and,
the method further comprising:
in response to comparing the brightened image (B) to the dynamic reference (AI), presenting the brightened image (B) in the first illumination environment.

4. The method of claim 3 wherein accepting the relative ambient illumination value (λ) for the first illumination environment includes measuring ambient illumination in the first illumination environment.

5. The method of claim 4 wherein measuring the ambient illumination value in the first illumination environment includes:
measuring X=a radiant flux value;
accepting a first display gamma characteristic (γ);
calculating λ=(X/Y)^{1/γ};
where Y is a reference ambient illumination corresponding to a reference illumination environment;
wherein presenting the brightened image (B) includes presenting the brightened image (B) on the first display.

6. The method of claim 1 wherein comparing the brightened image (B) to the dynamic reference (AI) includes comparing luminance, contrast, and structure components.

7. The method of claim 6 wherein comparing the brightened image (B) and dynamic reference (AI) contrast components includes calculating as follows:
$$C ( AI , B ) = \frac{2 {σ}_{AI} {σ}_{B} + {C}_{2}}{{σ}_{AI}^{2} + {σ}_{B}^{2} + {C}_{2}}$$
where σ=a standard deviation value; and,
C₂=a first constant.

8. The method of claim 7 wherein comparing the brightened image (B) and dynamic reference (AI) structure components includes calculating as follows:
$$S ( AI , B ) = \frac{{σ}_{AIB} + {C}_{3}}{{σ}_{AI} {σ}_{B} + {C}_{3}}$$
where C₃=a second constant.

9. The method of claim 8 wherein comparing the brightened image (B) and dynamic reference (AI) luminance components includes calculating as follows:
$$L ( AI , B ) = \frac{2 {μ}_{AI} {μ}_{B} + {K}_{1}}{{μ}_{AI}^{2} + {μ}_{B}^{2} + {K}_{1}}$$
where μ=is a mean value;
K₁=K²L_{AI}L_{B};
K=a third constant, <<1;
L_{AI}=dynamic range in pixel values of AI; and,
L_{B}=dynamic range of pixel values of B.

10. The method of claim 9 wherein comparing the brightened image (B) and dynamic reference (AI) includes, subsequent to calculating the luminance, contrast, and structure components, calculating an ambient adaptive (AA) objective matrix as follows:
SSIM_{AA}(AI,B)=L(AI,B)^{α}C(AI,B)^{β}S(AI,B)^{η}
where α,β,η are weighting constants.

11. The method of claim 1 wherein accepting the brightened image (B) includes accepting a brightened image (B) expressed with a resolution of X hits; and,
wherein generating the dynamic reference (AI) includes generating a dynamic reference (AI) expressed with a resolution of greater than X bits.

12. A device for measuring image quality using an ambient adaptive objective brightness metric, the device comprising:
a non transitory memory;
a processor; and,
an illumination referencing application enabled as a sequence of instructions stored in the memory and executed by the processor, the illumination referencing application accepting an electronically formatted original image (I), an electronically formatted brightened image (B), obtained by modifying the original image, and a relative ambient illumination value (λ), the illumination referencing application generating a dynamic reference AI=Iλ and supplying a result of comparing the brightened image (B) to the dynamic reference (AI).

13. The device of claim 12 wherein the illumination referencing application accepts a brightened image (B) that is an illumination-modified original image.

14. The device of claim 12 wherein the illumination referencing application accepts a relative ambient illumination value (λ) for a first illumination environment; and,
the device further comprising:
a display monitor configured to present the brightened image (B) in the first illumination environment in response to the illumination referencing application comparison of the brightened image (B) to the dynamic reference (AI).

15. The device of claim 14 further comprising:
an illumination measurement module configured to measure illumination in the first illumination environment, and having an output to supply the relative ambient illumination value (λ) for the first illumination environment to the illumination referencing application.

16. The device of claim 15 wherein the illumination measurement module measures X=a radiant flux value;
wherein the display monitor has a first display gamma characteristic (γ); and,
wherein the illumination referencing application calculates λ=(X/Y)^{1/γ}:
where Y is a reference ambient illumination corresponding to a reference illumination environment.

17. The device of claim 12 wherein the illumination referencing application compares the brightened image (B) to the dynamic reference (AI) by comparing luminance, contrast, and structure components.

18. The device of claim 17 wherein the illumination referencing application compares brightened image (B) and dynamic reference (AI) contrast components by calculating:
$$C ( AI , B ) = \frac{2 {σ}_{AI} {σ}_{B} + {C}_{2}}{{σ}_{AI}^{2} + {σ}_{B}^{2} + {C}_{2}}$$
where σ=a standard deviation value; and,
C₂=a first constant.

19. The device of claim 18 wherein the illumination referencing application compares brightened image (B) and dynamic reference (AI) structure components by calculating:
$$S ( AI , B ) = \frac{{σ}_{AIB} + {C}_{3}}{{σ}_{AI} {σ}_{B} + {C}_{3}}$$
where C₃=a second constant.

20. The device of claim 19 wherein the illumination referencing application compares brightened image (B) and dynamic reference (AI) luminance, components by calculating:
$$L ( AI , B ) = \frac{2 {μ}_{AI} {μ}_{B} + {K}_{1}}{{μ}_{AI}^{2} + {μ}_{B}^{2} + {K}_{1}}$$
where μ=a mean value;
K₁=K²L_{AI}L_{B};
K=a third constant, <<1;
L_{AI}=dynamic range in pixel values of AI; and,
L_{B}=dynamic range of pixel values of B.

21. The device of claim 20 wherein the illumination referencing application, subsequent to calculating the luminance, contrast, and structure components, calculates an ambient adaptive (AA) objective matrix as follows:
SSIM_{AA}(AI,B)=L(AI,B)^{α}C(AI,B)^{β}S(AI,B)^{η}
where α,β,η are weighting constants.

22. The device of claim 12 wherein the illumination referencing application accepts a brightened image (B) expressed with a resolution of X bits, and generates a dynamic reference AI expressed with a resolution of greater than X bits.
